(19) United States
(12) Patent Application Publication
(10) Pub. No.: US 2015/0227238 A1
(43) Pub. Date: Aug. 13, 2015

(54) TOUCH SENSOR AND DISPLAY DEVICE INCLUDING THE SAME

(71) Applicant: Samsung Electro-Mechanics Co., Ltd., Suwon-Si (KR)

(72) Inventors: Tae Young KIM, Suwon-Si (KR); Victor Yurlov, Suwon-Si (KR); Sang Hwan Oh, Suwon-Si (KR); Yoon Mi O, Suwon-Si (KR)

(73) Assignee: SAMSUNG ELECTRO-MECHANICS CO., LTD., Suwon-Si (KR)

(21) Appl. No.: 14/619,031

(22) Filed: Feb. 10, 2015

(30) Foreign Application Priority Data
Feb. 11, 2014 (KR) 10-2014-0015682
May 29, 2014 (KR) 10-2014-0065322

(51) Int. Cl. G06F 3/044

(52) U.S. Cl. CPC G06F 3/044; G06F 2203/04112

(57) ABSTRACT

A touch sensor may comprise a base substrate and an electrode pattern formed on one surface of the base substrate. The electrode pattern may be formed of a mesh pattern including a plurality of unit mesh patterns. Each of the unit mesh patterns may be formed in a rectangular shape including first and second sides facing each other. An acute angle θ1, formed by a horizontal line passing through a central point of the unit mesh pattern and the first side, and an acute angle θ2, formed by the horizontal line passing through the central point of the unit mesh pattern and the second side, may be different from each other.

### CROSS-REFERENCE TO RELATED APPLICATION

This application claims the benefit of Korean Patent Application No. 10-2014-0015682, filed on Feb. 11, 2014, entitled “Touch Sensor” and Korean Patent Application No. 10-2014-0065322, filed on May 29, 2014, entitled “Touch Sensor and Display Device Including the Same” which are hereby incorporated by reference in its entirety into this application.

### BACKGROUND

The present disclosure generally relates to a touch sensor and a display device including the same.

In accordance with the growth of computers using a digital technology, devices related to computers have been developed, and personal computers, portable transmitters, other personal information processors, and the like, execute text and graphic processing using various input devices such as a keyboard and a mouse.

In addition, techniques for input devices have progressed in high reliability, durability, innovation, designing and processing beyond a level of satisfying general functions. A touch sensor has also been developed as an input device capable of inputting information such as text, graphics, or the like.

In the touch sensor, a metal may be used to form an electrode pattern, as disclosed in the following Related Art Document (Patent Document). If the electrode pattern included in the touch sensor is formed using the metal, electric conductivity may be excellent and demand and supply are smooth.

### RELATED ART DOCUMENT

### [Patent Document]

Korean Patent Application Publication No 10-2011-0120157 A

### SUMMARY

An aspect of the present disclosure may provide a touch sensor and a display device including the same. In some embodiments of the present disclosure, the touch sensor may be capable of having improved visibility by decreasing visibility of an electrode pattern configuring the touch sensor and capable of decreasing visibility of an electrode pattern of a touch sensor. The touch sensor in some embodiments may effectively secure transmissivity by adjusting angles of sides forming a mesh pattern configuring the electrode pattern and a period value by a spacing distance at which the respective sides forming the mesh pattern are continuously formed.

An exemplary embodiment of the present disclosure may be implemented by effectively designing angles of mesh patterns included in an electrode pattern, periods of the mesh patterns based on a predetermined direction, and/or a relationship with pixels, or the like, of a display unit coupled to the touch sensor in order to decrease visibility of the electrode pattern configuring the touch sensor.

In addition, in some embodiments, angles of polygons configuring the mesh pattern included in the electrode pattern or a criterion by which the polygons are arranged in a predetermined direction may be adjusted, thereby making it possible to decrease visibility of the mesh pattern and/or prevent a moiré phenomenon through the electrode pattern.

Further, in some embodiments, angles, periods or intervals of the electrode patterns and pixel patterns of the display unit may be effectively adjusted in order to prevent the moiré phenomenon and/or decrease the visibility of the electrode pattern in a region overlapping between the electrode patterns or the electrode pattern and the display unit.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of a touch sensor according to an exemplary embodiment of the present disclosure;

FIG. 2 is a partial plan view of an electrode pattern of a mesh pattern according to an exemplary embodiment of the present disclosure;

FIG. 3 is a partial plan view of a pixel of a display unit according to an exemplary embodiment of the present disclosure;

FIG. 4 is a cross-sectional view of a display device according to an exemplary embodiment of the present disclosure;

FIG. 5 is a plan view of an electrode pattern of FIG. 4 according to an exemplary embodiment of the present disclosure;

FIG. 6 is a cross-sectional view of a display device according to another exemplary embodiment of the present disclosure; and

FIG. 7 is a cross-sectional view of a display device according to still another exemplary embodiment of the present disclosure.

### DETAILED DESCRIPTION

The objects, features and advantages of the present disclosure will be more clearly understood from the following detailed description of the exemplary embodiments taken in conjunction with the accompanying drawings. Throughout the accompanying drawings, the same reference numerals are used to designate the same or similar components, and redundant descriptions thereof are omitted. Further, in the following description, the terms “first,” “second,” “one side,” “the other side” and the like are used to differentiate a certain component from other components, but the configuration of such components should not be construed to be limited by the terms. Further, in the description of the present disclosure, when it is determined that the detailed description of the related art would obscure the gist of the present disclosure, the description thereof will be omitted.

Hereinafter, exemplary embodiments of the present disclosure will be described in detail with reference to the accompanying drawings.

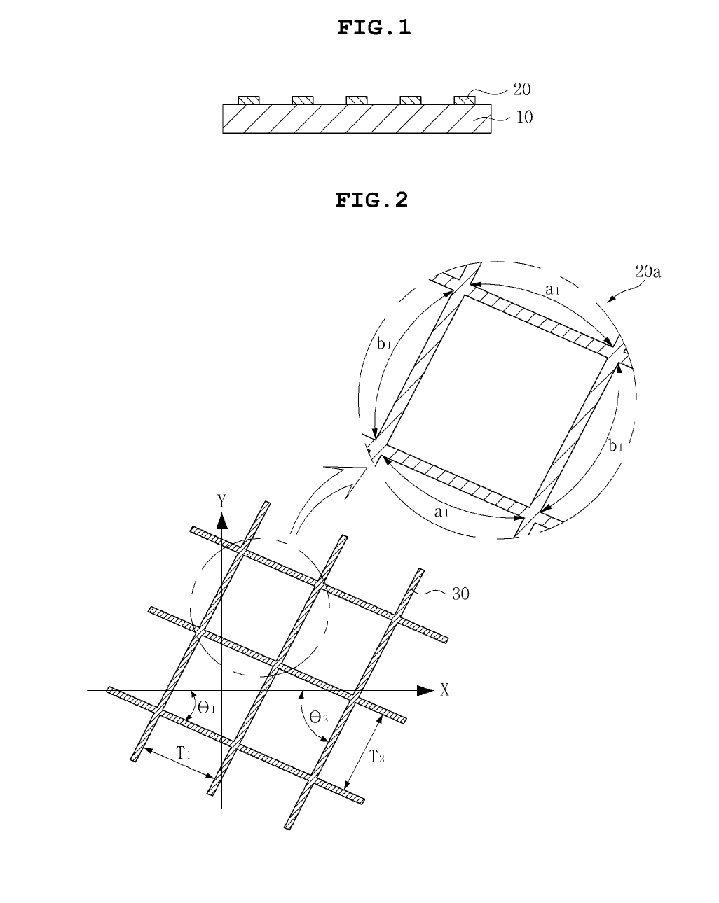

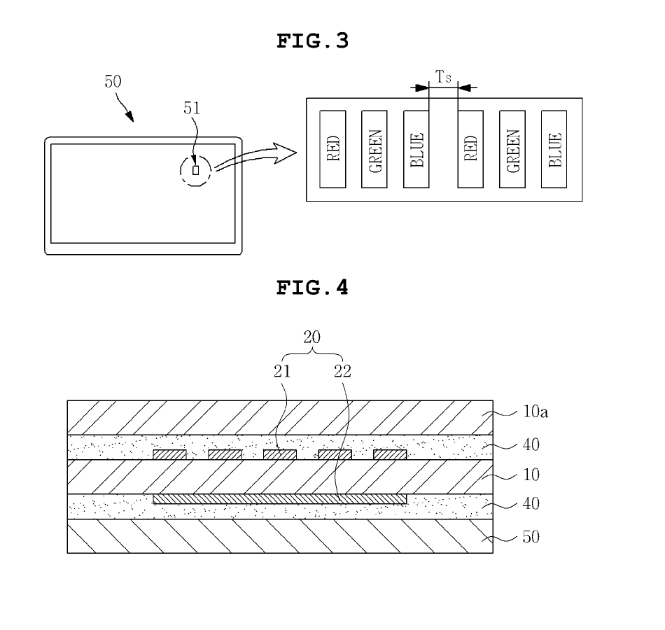

FIG. 1 is a cross-sectional view of a touch sensor according to an exemplary embodiment of the present disclosure; FIG. 2 is a partial plan view of an electrode pattern of a mesh pattern according to an exemplary embodiment of the present disclosure; and FIG. 3 is a partial plan view of a pixel 51 of a display unit according to an exemplary embodiment of the present disclosure.

A touch sensor according to an exemplary embodiment of the present disclosure may be configured to include a base substrate 10 and one or more electrode patterns 20 formed on one surface of the base substrate 10. The electrode pattern 20 may be formed of a mesh pattern including a plurality of unit mesh patterns 20a. Each of the unit mesh patterns 20a may be formed in a rectangular shape including first and second sides facing each other. An acute angle θ1 formed by a horizontal line passing through a central point of the unit mesh pattern 20a, such as the x-axis shown in FIG. 2, and the first side a1 and an acute angle θ2 formed by the horizontal line passing through the central point of the unit mesh pattern 20a and the second side b1 may be different from each other.

The base substrate 10 of the touch sensor may be made of any material that has predetermined strength or more and/or transmissivity of 85% or more and may output an image of a display unit 50. For example, the base substrate 10 may be made of polyethylene terephthalate (PET), polycarbonate (PC), poly methyl methacrylate (PMMA), polyethylene naphthalate (PEN), polyethersulfone (PES), cyclic olefin polymer (COP), triacetylcellulose (TAC) film, polyvinyl alcohol (PVA) film, polyimide (PI) film, polystyrene (PS), biaxially stretched polystyrene (K resin containing biaxially oriented PS; BOPS), glass, tempered glass, or the like. In addition, since the electrode pattern 20 may be formed on one surface of the base substrate 10, a surface treatment layer (not shown) may be formed on one surface of the base substrate 10 by performing high frequency treatment, primer treatment, or the like, in order to improve adhesion between the base substrate 10 and the electrode pattern 20.

The electrode pattern 20 may be formed on one surface of the base substrate 10. In the touch sensor according to an exemplary embodiment of the present disclosure, first and second electrode patterns 21 and 22 intersecting with each other may be both formed on one surface of the base substrate 10 or may be formed on one surface and the other surface of the base substrate 10, respectively. Alternatively, for example, as shown in FIG. 7, the first electrode pattern 21 may be formed on one surface of a first base substrate 11 and the second electrode pattern 22 may be formed on a second substrate 12, which is a separate substrate from the first base substrate 11. Here, the electrode pattern 20 may be formed of the mesh pattern having metal fine lines 30, and a shape of the mesh pattern may be a four-sided figure, such as a rectangular shape, or the like. In an exemplary embodiment of the present disclosure, for illustration purposes only, the electrode pattern 20 formed of the unit mesh pattern 20a having a rectangular shape will be mainly described. The electrode pattern 20 may be formed of the mesh pattern using at least one selected from a group consisting of copper (Cu), aluminum (Al), gold (Au), silver (Ag), titanium (Ti), palladium (Pd), chromium (Cr), nickel (Ni), or an alloy thereof.

Meanwhile, the electrode pattern 20 may also be made of metal silver, for example, formed by exposing/developing a silver salt emulsion layer, a metal oxide such as an indium thin oxide (ITO), or the like, a conductive polymer such as poly-3, 4-ethylenedioxythiophene/polystyrenesulfonate (PEDOT/PSS), or the like, having excellent flexibility and/or using a simple coating process, in addition to the above-mentioned metal.

The electrode pattern 20 may be formed by, for example, a dry process, a wet process, or a direct patterning process. The dry process may include a sputtering process, an evaporation process, or the like; the wet process may include a dip coating process, a spin coating process, a roll coating process, a spray coating process, or the like; and the direct patterning process may include a screen printing process, a gravure printing process, an inkjet printing process, or the like.

In addition, a photosensitive material may be applied onto the electronic pattern 20 on a substrate using a photolithograph and light may be irradiated onto a mask formed in a desired pattern. Then, a developing process for forming a desired pattern, for example, removing a portion of the photosensitive material to which the light is irradiated using a developer, removing other portion of the photosensitive material to which the light is not irradiated using a developer, or the like, may be performed. Then, the photosensitive material may be formed in a specific pattern, and the remaining portion is removed by an etchant by using the photosensitive material as a resist. Then, when the photosensitive material is removed, the electrode pattern 20 having a desired pattern may be formed.

As shown in FIG. 2, the electrode pattern 20 may be formed of the plurality of unit mesh patterns 20a. Here, each of the unit mesh patterns 20a may be formed in, for example, but not limited to, the rectangular shape including the first and second sides a1 and b1 facing each other, and the acute angle θ1 formed by the horizontal line (for instance, in FIG. 2, the X-axis is shown as the horizontal line) passing through the central point of the unit mesh pattern 20a and the first side a1 and the acute angle θ2 formed by the horizontal line passing through the central point of the unit mesh pattern 20a and the second side b1 may be different from each other. As described above, the mesh pattern having the rectangular shape in which two sides a1 and b1 having different acute angles face each other, respectively, is formed, thereby making it possible to reduce the visibility of the electrode pattern 20 that may occur by points at which the metal fine lines 30 intersect with each other. For example, when θ1 and θ2 are 30 degrees or less or 60 degrees or more, the visibility of intersection points on patterns at which the metal fine lines 30 of the mesh pattern intersect with each other may be large, such that the visibility of the electrode pattern 20 may be increased. However, the mesh pattern may be formed at different angles of θ1 and θ2 to reduce the visibility of the electrode pattern 20.

For example, the sum of the acute angles θ1 and θ2 may be 60 to 120 degrees. In the case in which the sum of θ1 and θ2 is less than 60 degrees, the visibility of the electrode pattern 20 may be decreased due to the visibility of the intersection points of the metal fine lines 30. In the case in which the sum of θ1 and θ2 exceeds 120 degrees, entire transmissivity of the electrode pattern 20 may be decreased.

In addition, since the visibility of metal forming the electrode pattern 20, that is, cognitive power of eyes of a person, may be decreased by a contrast sensitivity function (CSF) as a frequency become high, a plurality of unit mesh patterns 20a arranged in any one side direction are arranged at a high frequency. In this case, a plurality of unit mesh patterns 20a arranged in the other side direction may be arranged at a low frequency in order to improve transmissivity generated by improvement of a period T (pitch), such that both of visibility and transmissivity of a metal line may be considered.

For instance, a period T and an angle θ according to an exemplary embodiment of the present disclosure may be implemented as follows, thereby making it possible to more effectively form the electrode pattern 20.

TABLE 1

| T1 (μm) | T2 (μm) | Θ1 (°) | Θ2 (°) |
|---|---|---|---|
| 118.3 | 118.3 | 18.7 | 63.5 |
| 105.1 | 120.7 | 15.82 | 63.46 |
| 181.8 | 83.3 | 33 | 53 |
| 181.8 | 87 | 55 | 30 |
| 181.8 | 91.7 | 55 | 20 |

In detail, an interval period T1 between the first sides a1 facing each other in one side direction on the unit mesh pattern 20a and an interval period T2 between the second sides b1 facing each other in the other side direction on the unit mesh pattern 20a may be different from each other. That is, the respective periods are designed so as to be different from each other, thereby making it possible to decrease entire visibility of the mesh pattern and prevent a moiré phenomenon with a pixel 51 pattern, or the like, of the display unit 50 that may be viewed due to overlap between the electrode patterns 20 or between the pixel 51 pattern and the electrode pattern 20.

In addition, when reciprocal numbers of the interval period T1 between the first sides a1 facing each other in one side direction on the unit mesh pattern 20a and the interval period T2 between the second sides b1 facing each other in the other side direction on the unit mesh pattern 20a are F1 and F2, respectively, the electrode pattern 20 of the touch sensor may be formed so as to satisfy the following conditions: 15<F1 and/or 15<F2. In the case in which F1 is 15 or less and/or F2 is 15 or more, a moiré phenomenon may occur between pixels 51 of a display unit 50 coupled to the plurality of unit mesh patterns 20a, and transmissivity and visibility of the electrode pattern 20 may be decreased.

In addition, when a period or interval of pixels 51 formed on the display unit 50 coupled to the touch sensor is Ts and a reciprocal number of the period Ts is Fs, the following conditions may be satisfied: F1>Fs/3 and/or F2>Fs/3.

In addition, the electrode pattern 20 may be formed so as to simultaneously satisfy the following conditions:

15<F1

15<F2

F1>Fs/3

F2>Fs/3.

According to these relational conditions of the respective cases, together with patterns with different acute angles θ1 and θ2 formed by the respective sides and the horizontal line (for example, the X-axis shown in FIG. 2), the interval periods T1 and T2 of the respective metal fine lines 30 of the unit mesh patterns 20a continuous in one direction and the interval period Ts of unit pixels 51 of the display unit 50 coupled to the touch sensor may be effectively arranged so as to correspond to each other to decrease the visibility of the electrode pattern 20 of the touch sensor and more effectively prevent a moiré phenomenon that may occur at the time of coupling the touch sensor to the display unit 50 thereby making it possible to further improve the visibility of the touch sensor.

The respective requirements of the acute angles θ1 and θ2 formed by the respective sides on the unit mesh pattern 20a and the horizontal line or the periods T1 and T2 described above may be selectively satisfied or all of the respective requirements may be satisfied to more effectively decrease the visibility of the electrode pattern 20 formed of the mesh pattern and the occurrence of the moiré phenomenon.

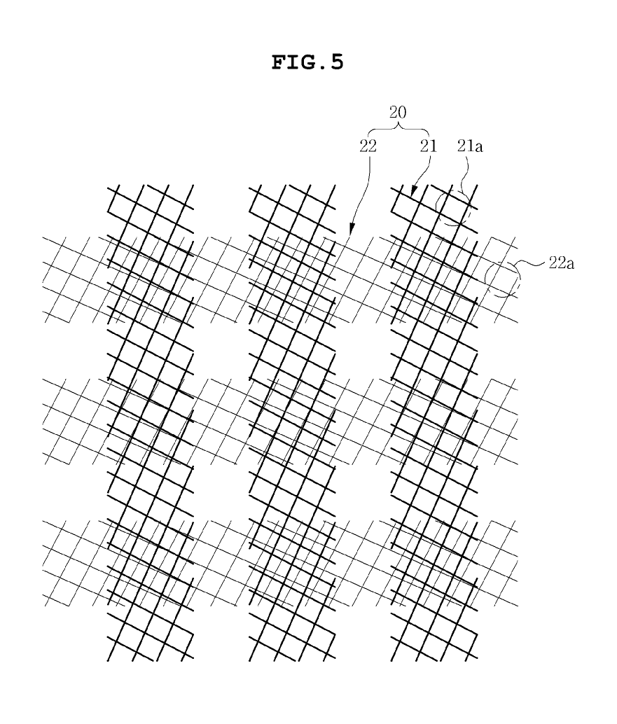

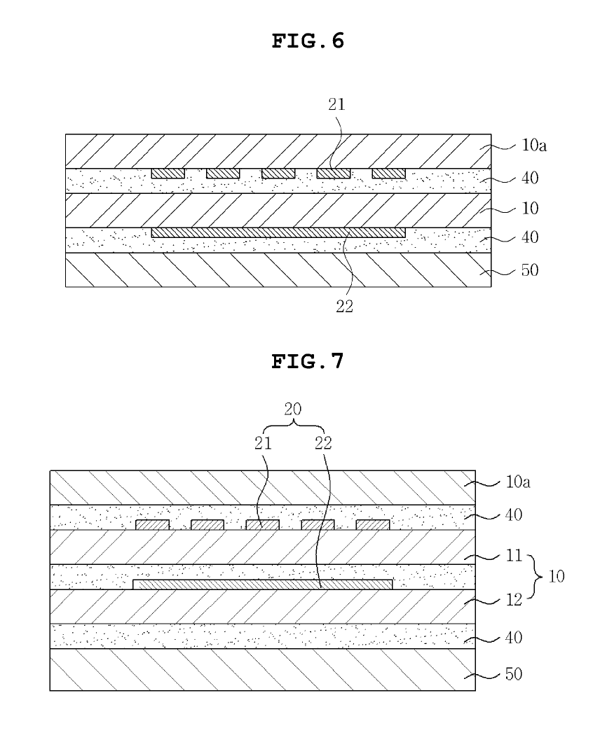

FIG. 4 is a cross-sectional view of a display device according to an exemplary embodiment of the present disclosure; FIG. 5 is a plan view of an electrode pattern 20 of FIG. 4 according to an exemplary embodiment of the present disclosure; FIG. 6 is a cross-sectional view of a display device according to another exemplary embodiment of the present disclosure; and FIG. 7 is a cross-sectional view of a display device according to still another exemplary embodiment of the present disclosure.

As shown in FIGS. 4 and 5, in various exemplary embodiments of the present disclosure, the first and second electrode patterns 21 and 22 may be formed on one surface and the other surface of the base substrate 10, respectively. The first electrode pattern 21 and the second electrode pattern 22 may be formed as a sensing electrode and a driving electrode, respectively, and may be formed so as to intersect with each other. The first electrode pattern 21 may be formed of a plurality of first unit mesh patterns 21a, and the second electrode pattern 22 may be formed of a plurality of second unit mesh patterns 22a. In this case, since the conditions of the periods of the unit mesh pattern 20a and the angles formed by sides of the unit mesh pattern 20a and the horizontal line described above may be similarly applied to relationships between shapes and arrangements of the first and second unit mesh patterns 21a and 22a, a detailed description thereof will be omitted. Here, the first and second unit mesh patterns 21a and 22a may be formed in the same or similar shape so as to correspond to each other.

In addition, in a region in which the first and second electrode patterns 21 and 22 intersect with each other, the first and second unit mesh patterns 21a and 22a included in the first and second electrode patterns 21 and 22, respectively, may be formed in the same or similar pattern so as to correspond to each other. That is, the first and second unit mesh patterns 21a and 22a may be formed so as to match each other in a region in which the first and second electrode patterns 21 and 22 are overlapped with each other in order to decrease the visibility and prevent the moiré phenomenon in a portion in which the first and second electrode patterns 21 and 22 are overlapped with each other within a region in which the first and second electrode patterns 21 and 22 intersect with each other.

The first and second electrode patterns 21 and 22 may be formed on or over both surfaces of the base substrate 10, respectively, and a display part 50 may be coupled in one side direction of the base substrate 10. A window substrate 10a may be further included in the other direction of the base substrate 10 that is viewed by a user. The window substrate 10a may be made of a material similar to that of the base substrate 10 described above. However, the window substrate 10a may also be made of a material having strength, such as tempered glass, or the like, for protection of the electrode patterns 21 and 22 and rigidity of the touch sensor.

The display part 50, which is an image device, may include various display devices such as a liquid crystal display (LCD), an organic light emitting diode (OLED), or the like, but is not limited to a specific kind of device. The display device including a plurality of pixels 51 has been described in an exemplary embodiment of the present disclosure, and related configurations of the display device may be readily changed by those skilled in the art.

As shown in FIG. 6, in a touch sensor and a display device including the same according to another exemplary embodiment of the present disclosure, the touch sensor may be implemented by forming the electrode pattern 20 on the window substrate 10a. For example, the first electrode pattern 21 may be formed on an opposite surface to one surface of the window substrate 10a viewed by the user, and the second electrode pattern 22 intersecting with the first electrode pattern 21 may be formed on a base substrate 10, which is a separate substrate from the window substrate 10a. The window substrate 10a on which the first electrode pattern 21 is formed and the base substrate 10 on which the second electrode pattern 22 is formed may be coupled to each other by an adhesive layer 40. The display unit 50 may be coupled onto the second electrode pattern 22 by the adhesive layer 40. For example, the adhesive layer 40 may be made of an optical clear adhesive (OCA), which is a transparent adhesive layer, for transmissivity of the touch sensor. However, a material of the adhesive layer 40 is not particularly limited as long as it is matched to characteristics of the adhesive layer 40.

In addition, as shown in FIG. 7, in a touch sensor and a display device including the same according to still another exemplary embodiment of the present disclosure, the first electrode pattern 21 may be formed on one surface of a first base substrate 11, and the second electrode pattern 22 intersecting with the first electrode pattern 21 may be formed on one surface of a second base substrate 12, which is a separate substrate from the first base substrate 11. The window substrate 10a may be coupled in one side direction of the first base substrate 11 on which the first electrode pattern 21 is formed, by the adhesive layer 40, and the display unit 50 may be coupled in the other side direction of the second base substrate 12 on which the second electrode pattern 22 is formed.

The touch sensors according to exemplary embodiments of the present disclosure having different structures have been shown in FIGS. 6 and 7. Since the first and second electrode patterns 21 and 22 included in these touch sensors and the plurality of first unit mesh patterns 21a configuring the first electrode pattern 21 and the second mesh pattern 22a configuring the second electrode pattern 22 are similar to the electrode pattern 20 and the unit mesh pattern 20a described above, a detailed description thereof will be omitted in order to avoid an overlapped description.

Although the embodiments of the present disclosure have been disclosed for illustrative purposes, it will be appreciated that the present disclosure is not limited thereto, and those skilled in the art will appreciate that various modifications, additions and substitutions are possible, without departing from the scope and spirit of the disclosure.

Accordingly, any and all modifications, variations or equivalent arrangements should be considered to be within the scope of the disclosure, and the detailed scope of the disclosure will be disclosed by the accompanying claims.

What is claimed is:

1. A touch sensor comprising:
a base substrate; and
an electrode pattern formed on one surface of the base substrate,
wherein:
the electrode pattern is formed of a mesh pattern including a plurality of unit mesh patterns,
each of the unit mesh patterns has a four-sided figure including first and second sides facing each other,
an acute angle θ1, formed by a horizontal line passing through a central point of the unit mesh patterns and the first side, and an acute angle θ2, formed by the horizontal line and the second side, are different from each other, and
an interval T1 between the first sides formed in one direction on the electrode pattern and an interval T2 between the second sides formed in another direction on the electrode pattern are different from each other.

2. The touch sensor of claim 1, wherein a sum of the acute angles θ1 and θ2 is 60 to 120 degrees.

3. The touch sensor of claim 1, wherein a reciprocal number F1 of the interval T1 and a reciprocal number F2 of the interval T2 satisfy the following conditions:
15<F1
15<F2.

4. The touch sensor of claim 1, wherein a width of metal fine lines configuring the unit mesh patterns is 1 to 10 μm.

5. A display device comprising:
the touch sensor of claim 1; and
a display unit formed on an other surface of the base substrate of the touch sensor,
wherein a reciprocal number Fs of an interval Ts between pixels 51 formed in the display unit, a reciprocal number F1 of the interval T1, and a reciprocal number F2 of the interval T2 satisfy the following conditions:
15<F1
15<F2
F1>Fs/3
F2>Fs/3.

6. A touch sensor comprising:
a base substrate; and
a first electrode pattern formed on one surface of the base substrate; and
a second electrode pattern formed on an other surface of the base substrate and formed in a direction intersecting with the first electrode pattern,
wherein the first electrode pattern includes a plurality of first unit mesh patterns, the second electrode pattern includes a plurality of second unit mesh patterns, the first and second unit mesh patterns are formed in a four-sided figure including first and second sides facing each other, and an acute angle θ1, formed by a horizontal line passing through a central point of the first and second unit mesh patterns and the first side, and an acute angle θ2, formed by the horizontal line and the second side, are different from each other, and
wherein an interval T1 between the first sides formed in one direction on the first electrode pattern or the second electrode pattern and an interval T2 between the second sides formed in another direction on the first electrode pattern or the second electrode pattern are different from each other.

7. The touch sensor of claim 6, wherein the first and second unit mesh patterns are formed in the same shape so as to correspond to each other.

8. The touch sensor of claim 6, wherein in a region in which the first and second electrode patterns intersect with each other, the first and second unit mesh patterns included in the first and second electrode patterns are formed in the same pattern so as to correspond to each other.

9. The touch sensor of claim 6, wherein a sum of the acute angles θ1 and θ2 is 60 to 120 degrees.

10. The touch sensor of claim 6, wherein a reciprocal number F1 of the interval T1 and a reciprocal number F2 of the interval T2 satisfy the following conditions:
15<F1
15<F2.

11. A display device comprising:
the touch sensor of claim 6;
a display unit formed on the other surface of the base substrate of the touch sensor,
wherein a reciprocal number Fs of an interval Ts between pixels 51 formed in the display unit, a reciprocal number F1 of the interval T1, and a reciprocal number F2 of the interval T2 satisfy the following conditions:
15<F1
15<F2
F1 >Fs/3
F2 >Fs/3.
